(19) United States
(12) Patent Application Publication
(10) Pub. No.: US 2012/0324844 A1
(43) Pub. Date: Dec. 27, 2012

(54) FILTER ASSEMBLY FOR USE IN A BAGHOUSE

(76) Inventor: Tian Xuan Zhang, Overland Park, KS (US)

(21) Appl. No.: 13/169,655

(22) Filed: Jun. 27, 2011

(51) Int. Cl. B01D 46/00; F16L 23/00; B23P 11/00

(52) U.S. Cl. 55/378; 29/428; 285/405

(57) ABSTRACT

A filtration system for use in a turbine flow path is provided. The filtration system includes a cartridge filter and an attachment portion coupled to the cartridge filter, the attachment portion configured to couple the cartridge filter to a tube sheet, such that the tube sheet is secured within an annular cavity defined between a first flange and a second flange extending from the attachment portion.

### BACKGROUND OF THE INVENTION

The field of the invention relates generally to filter assemblies for use in baghouses, and more particularly, to baghouses in industrial filtration applications.

Fabric filters are commonly used to remove particulate matter from an air stream in an industrial air filtration system. For example, such filters are often used in known baghouses. At least some known baghouses include a housing that has an inlet that receives dirty, particulate-containing air, and an outlet through which clean air is discharged from the baghouse. In such baghouses, often the interior of the housing is divided, by a tube sheet, into a dirty air or upstream plenum, and a clean air or downstream plenum. Air flows through the inlet into the dirty air plenum, through the filters, and into the clean air plenum before clean air is discharged through the outlet of the clean air plenum. Known tube sheets are formed with a plurality of apertures that couple the dirty air plenum in flow communication with the clean air plenum through the filters. More specifically, in known tube sheets, each of the filter elements is mounted about a respective aperture such that at least a portion of the filter element extends through the assorted aperture.

More specifically, in such baghouses, to clean dirty air, a plurality of tubular fabric filters, referred to as cartridge filters may be used. Such cartridge filters are typically mounted in a vertical or horizontal orientation within the baghouse, such that streams of a dust-laden gas to be filtered are passed through the filters prior to the gas entering the clean air plenum.

Although such baghouses are commonly used, because of the different designs, manufacturing tolerances and variations, known tube sheets may be unintentionally formed with multiple-sized apertures. Because of the variation in the size of the apertures, dust leakage around the filters is possible. Moreover, depending on the aperture size there is only one sized filter to fit tube sheet apertures.

### BRIEF DESCRIPTION OF THE INVENTION

In one aspect, a filtration system for use in a turbine flow path is provided. The filtration system includes a cartridge filter and an attachment portion coupled to the cartridge filter, the attachment portion configured to couple the cartridge filter to a tube sheet, such that the tube sheet is secured within an annular cavity defined between a first flange and a second flange extending from the attachment portion.

In another aspect, an attachment portion for use with a cartridge filter. The attachment portion includes a first flange extending radially outward and configured to securely couple against a first side of a tube sheet and a second flange extending radially outward and configured to securely couple against a second side of a tube sheet, the second flange spaced from the first flange such that an annular cavity is defined therebetween, the cavity sized to receive the tube sheet therein.

In another aspect, method for assembling a filtration system for use with a turbine assembly is provided. The method includes providing a cartridge filter, coupling an attachment portion to the cartridge filter, wherein the attachment portion includes a cavity that is defined between a first flange and a second flange that is spaced a distance from the first flange, and coupling the attachment portion to a tube sheet within the turbine assembly, such that the tube sheet is secured in the cavity between the first and second flanges.

### BRIEF DESCRIPTION OF THE DRAWINGS

FIG. 1 is a schematic illustration of an exemplary filtration system that may be used with the turbine engine assembly shown in FIG. 1.

FIG. 2 is a schematic illustration of an exemplary filter assembly that may be used with the filtration system shown in FIG. 1.

FIG. 3 is a schematic illustration of an alternative filter assembly that may be used with the filtration system shown in FIG. 1.

### DETAILED DESCRIPTION OF THE INVENTION

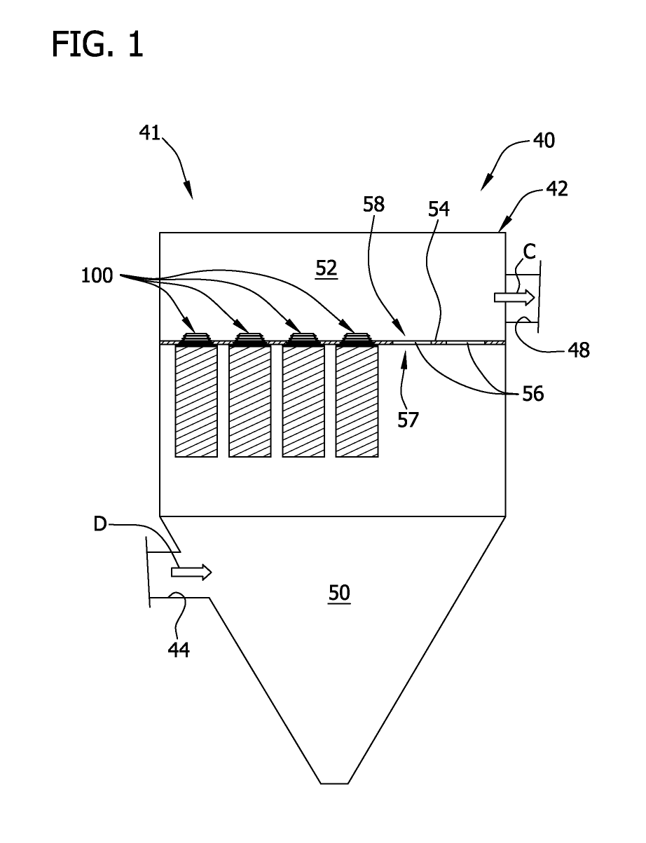

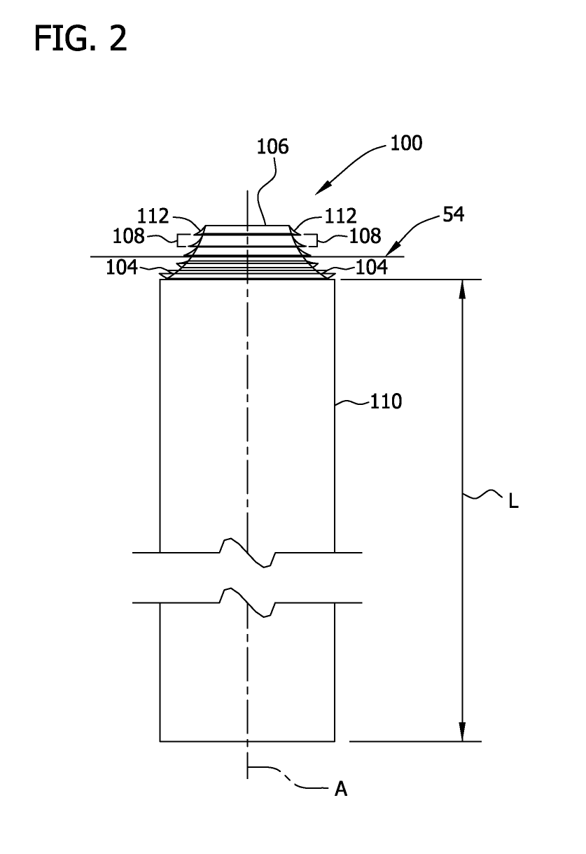

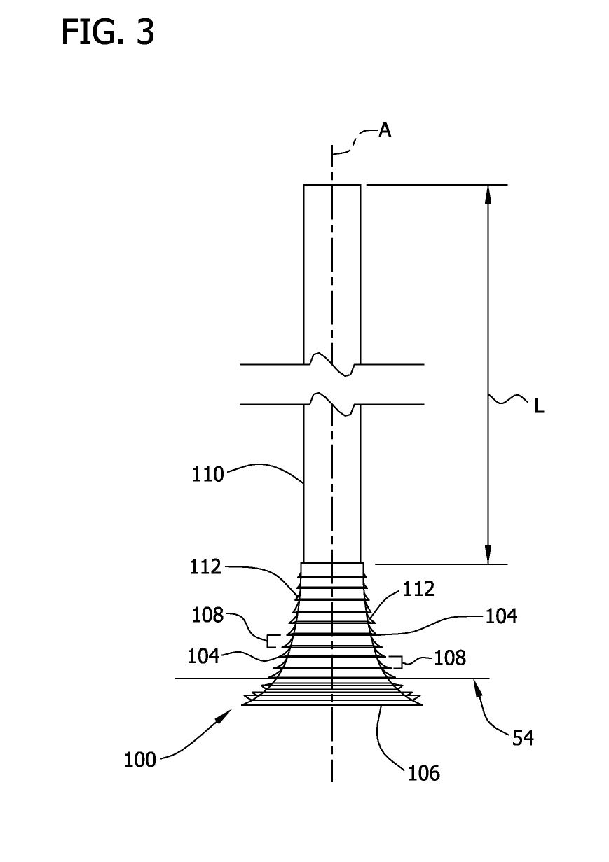

FIG. 1 is a schematic illustration of an exemplary filtration system 41 that is contained in air plenum or baghouse 40. FIGS. 2 and 3 are enlarged cross-sectional views of exemplary filter assemblies 46 that may be used with filtration system 41. In the exemplary embodiment, baghouse 40 includes a housing 42 that includes an inlet 44 and an outlet 48 that is downstream from inlet 44. A tube sheet 54 that extends across baghouse 40 divides baghouse 40 into a dirty air plenum 50 and a clean air plenum 52. As used herein, the terms “dirty air” and/or “dirty gas” are defined as particulate-containing air and/or gas, and the terms “clean air” and/or “clean air” are defined as air and/or gas that has had substantially all particulate matter removed therefrom.

In the exemplary embodiment, tube sheet 54 is fabricated from a heat-resistive material, such as sheet metal, and includes at least a portion that is substantially planar. The planar portion of tube sheet 54 includes a plurality of apertures 56 defined therein. In the exemplary embodiment, tube sheet 54 is positioned against the inner walls of the outer periphery of baghouse 40 such that apertures 56 are the only locations within baghouse 40 that couple the dirty air plenum 50 and the clean air plenum together in flow communication. In the exemplary embodiment, apertures 56 are substantially evenly spaced across tube sheet 54. Alternatively, apertures 56 can have any spacing and/or orientation that allows baghouse 40 to function as described herein.

Each filter assembly 46 is coupled to tube sheet 54 such that each assembly is adjacent to a respective aperture 56. More specifically, each filter assembly 46 is coupled against tube sheet 54 such that each assembly 46 extends at least partially through a respective aperture 56. As such, in the exemplary embodiment, each filter assembly 46 is positioned against both a dirty air side 57 and a clean air side 58 of tube sheet 54 as described in more detail below. Moreover, when fully assembled, dirty gas plenum 50 is substantially isolated from clean gas plenum 52 other than being coupled in flow communication via apertures 56. Although, filter assemblies 46 are illustrated as being vertically oriented, it should be noted that tube sheet 54 and filter assemblies 46 can be mounted in any relative orientation that enables baghouse 40 to function as described herein.

In the exemplary embodiment, each filter assembly 46 includes an attachment portion 100 that is coupled to a cartridge filter 110. More specifically, in the exemplary embodiment, each cartridge filter 110 at least substantially circumscribes attachment portion 100. In one embodiment, cartridge filter 110 is potted in attachment portion 100 Cartridge filters 110 may be constructed of any material that enables a desired level of filtering to be satisfied based on the operating conditions of baghouse 40. For example, filter 110 may be fabricated from materials such as, but not limited to polyester, polypropylene, aramid, acrylic, fiberglass, and ePTFE.

Each attachment portion 100 includes a plurality of tube sheet flanges 104 that extend outward from attachment portion base 106. In the exemplary embodiment, flanges 104 are oriented such that a cavity 108 is defined between flanges 104. Cavity 108, as described in more detail below, is sized and shaped to receive tube sheet 54 therein. Tube sheet flanges 104 each include a substantially planar surface 114 and a substantially tapered surface 112. Tapered surface 112 facilitates attachment portion 100 being inserted into tube sheet 54. Attachment portion 100 may be fabricated from materials that are substantially impervious to air and fluid, such as, but not limited to epoxy, silicone, and urethane, etc.

In the exemplary embodiment, attachment portion 100 is bonded to filter 110 via a molding process in which filter 110 is securely coupled to attachment portion 100. In such an embodiment, as attachment portion 100 cures, filter 110 is chemically bonded to attachment portion 100. In an alternative embodiment, cartridge filter 110 is securely coupled to attachment portion 100 via a welding process, such as a sonic welding process. In another embodiment, cartridge filter 110 is securely coupled to attachment portion 100 via an adhesive process. Alternatively, any other bonding technique can be used to securely couple cartridge filter 110 to attachment portion 100.

Referring specifically to FIG. 2, in the exemplary embodiment, attachment portion base 106 is fabricated with a concave cross-sectional profile that extends from cartridge filter 110. In such an embodiment, each tube sheet flange 104 has a different diameter than the other tube sheet flanges 104. In the exemplary embodiment, the diameter of each tube sheet flange 104 progressively decreases in size from the cartridge filter 110 outward towards portion base 106. Fabricating attachment portion 100 to include tube sheet flanges 104 that decrease in diameter enables filter assembly 46 to be pushed upward into tube sheet 54 until a desired fit is achieved.

Referring specifically to FIG. 3, in the exemplary embodiment, attachment portion base 106 is fabricated with a convex cross-sectional profile that extends from cartridge filter 110. In such an embodiment, each tube sheet flange 104 has a different diameter than the other tube sheet flanges 104. In the exemplary embodiment, the diameter of each tube sheet flange 104 progressively increases in size from the cartridge filter 110 outward towards portion base 106. Fabricating attachment portion 100 to include tube sheet flanges 104 that progressively increase in diameter enables filter assembly 46 to be pulled upward into tube sheet 54 until a desired fit is achieved.

In the exemplary embodiment, filter 110 is formed with a tubular orientation that has a substantially circular cross-sectional profile to be perpendicular to central axis A. Alternatively, filter media 110 may be formed in any shape or configuration that enables assemblies 46 to function as described herein. Filter media 110 may include any filter that enables assemblies 46 to function as described herein such as a bag filter. Filter assemblies 46 may be fabricated in any form from any filter media that enables filter assembly 41 to function as described herein, including but not limited to, circle, ellipse, and polygons, etc. Moreover, filter assemblies 46 may be formed with any desired length L that enables desired filtering requirements of baghouse 40 to be satisfied.

When filter assembly 46 is inserted into tube sheet 54, tapered surface 112 of flange 104 facilitates attachment portion 100 being inserted into tube sheet 54 in a snap-fit configuration. In the exemplary embodiment, tube sheet 54 is seated in cavity 108 such that an outer periphery of each aperture 56 is in sealing contact with attachment portion 100. Moreover, when tube sheet 54 is seated in cavity 108 tube sheet flange surfaces 110 and 112 are each coupled against tube sheet 54 in a friction fit such that sealing contact is made between flange surface 114 and tube sheet 54, and between flange surface 112 and tube sheet 54. In the exemplary embodiment, flanges 104 facilitate attachment portion 100 self-centering filter assembly 46 within tube sheet 54.

During operation, particulate-laden gas flow D enters inlet 44, and clean gas flow C is discharged through outlet 48 towards turbine engine inlet 30 (shown in FIG. 1). More specifically, particulate-laden flow D is filtered by assemblies 46 positioned within baghouse 40 and clean flow C exits through baghouse outlet 48. Dirty gas plenum 50 is substantially sealed from clean gas plenum 52 with filter assembly 46 such that flow communication therebetween is substantially prevented between dirty gas plenum 50 and clean gas plenum 52 except through assemblies 46. Tube sheet flanges 104 and 106 supports filter assembly 46 as the filter assembly 46 is suspended from tube sheet 54 as flow moves through filter assembly 46 during operation of baghouse 40.

The above described methods and systems provide a cost-effective filter assembly that can accommodate the aperture size variations found in baghouse tube sheets. The above described filter assemblies provide effective sealing of varying sized apertures within tube sheets, such that dust leakage around the filters is substantially prevented regardless of the size of the tube sheet apertures. The use of the above described filter assemblies also decreases the need to reject an entire set of cartridge filters that may be improperly sized to fit tube sheet apertures.

Exemplary embodiments of filter assembly for a baghouse or gas turbine inlet filtration system are described above in detail. The methods and systems are not limited to the specific embodiments described herein, but rather, components of systems and/or steps of the methods may be utilized independently and separately from other components and/or steps described herein. For example, the methods may also be used in combination with other filtration systems and methods, and are not limited to practice with only the turbine systems and methods as described herein. Rather, the exemplary embodiment can be implemented and utilized in connection with many other filtration or sealing applications such as but not limited to cement kilns, cement transfer stations, asphalt plants, foundries, lime kilns, coal fired power plant baghouses, fly ash handling, bin vents, wood processing dust collectors, spray driers, aluminum ore processing, steel mills, and food processing plants.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A filtration system for use in a flow path, said filtration system comprising:
a cartridge filter; and
an attachment portion coupled to said cartridge filter, said attachment portion configured to couple said cartridge filter to a tube sheet, such that the tube sheet is secured within an annular cavity defined between a first flange and a second flange extending from said attachment portion.

2. A filtration system in accordance with claim 1, wherein said first flange extends radially outward a distance across the tube sheet that is farther than a distance that said second flange extends across the tube sheet.

3. A filtration system in accordance with claim 1, wherein said second flange tapers from said cavity towards a centerline of said attachment portion.

4. A filtration system in accordance with claim 3, wherein said second flange is configured to flex as said attachment portion is coupled to the tube sheet.

5. A filtration system in accordance with claim 1, wherein said attachment portion has a concave cross-sectional shape.

6. A filtration system in accordance with claim 1, wherein said attachment portion has a convex cross-sectional shape.

7. A filtration system in accordance with claim 1, wherein said attachment portion is configured to self-center within an aperture defined in a tube sheet when said attachment portion is secured in the tube sheet.

8. An attachment portion for use with a cartridge filter, said attachment portion comprising:
a first flange extending radially outward and configured to securely couple against a first side of a tube sheet; and
a second flange extending radially outward and configured to securely couple against a second side of a tube sheet, said second flange spaced from said first flange such that an annular cavity is defined therebetween, said cavity sized to receive the tube sheet therein.

9. An attachment portion in accordance with claim 8, wherein said first flange extends radially outward a distance across the tube sheet that is farther than a distance that said second flange extends across the tube sheet.

10. An attachment portion in accordance with claim 8, wherein said second flange tapers from said cavity towards a centerline of said attachment portion.

11. An attachment portion in accordance with claim 8, wherein said second flange is configured to flex as said attachment portion is coupled to the tube sheet.

12. An attachment portion in accordance with claim 8, wherein said attachment portion has a concave cross-sectional shape.

13. An attachment portion in accordance with claim 8, wherein said attachment portion is configured to self-center within an aperture defined in a tube sheet when said attachment portion is secured in the tube sheet.

14. A method for assembling a filtration system for use with a baghouse, said method comprising:
providing a filter;
coupling an attachment portion to the filter, wherein the attachment portion includes a cavity that is defined between a first flange and a second flange that is spaced a distance from the first flange; and
coupling the attachment portion to a tube sheet within the baghouse, such that the tube sheet is secured in the cavity between the first and second flanges.

15. A method for assembling a filtration system in accordance with claim 14, wherein coupling an attachment portion to the tube sheet further comprises coupling the attachment portion to the tube sheet such that a first flange extends a distance radially outward across the tube sheet that is farther than a distance that the second flange extends across the tube sheet.

16. A method for assembling a filtration system in accordance with claim 14, wherein coupling an attachment portion to the cartridge filter further comprises coupling the attachment portion to the cartridge filter such that the second flange tapers from the cavity towards a centerline of the attachment portion.

17. A method for assembling a filtration system in accordance with claim 16, wherein coupling an attachment portion to the cartridge filter further comprises coupling the attachment portion to the cartridge filter such that the second flange is configured to flex as the attachment portion is coupled to the tube sheet.

18. A method for assembling a filtration system in accordance with claim 14, wherein coupling an attachment portion to the tube sheet further comprises coupling the attachment portion to the tube sheet in a snap fit arrangement.

19. A method for assembling a filtration system in accordance with claim 14, further comprising providing an attachment portion that has a substantially concave shape.

20. A method for assembling a filtration system in accordance with claim 14, further comprising providing an attachment portion that has a substantially concave shape.
